(19) United States
(12) Patent Application Publication
(10) Pub. No.: US 2012/0132516 A1
(43) Pub. Date: May 31, 2012

(54) Synthesis of Graphene Films Cycloalkanes

(76) Inventor: Paul A. Zimmerman, Phoenix, AZ (US)

(21) Appl. No.: 12/955,500

(22) Filed: Nov. 29, 2010

(51) Int. Cl. C01B 31/00; B01J 19/08; B01J 19/12; B82Y 40/00

(52) U.S. Cl. 204/157.41; 204/157.47; 977/901

(57) ABSTRACT

This invention provides, but is not limited to, methods for synthesizing graphene film from liquid hydrocarbons using deep ultraviolet light. Specifically, methods for synthesizing a graphene film from an alicyclic- or liquid aromatic-hydrocarbon are presented. Methods for forming a graphene film comprising a dopant are also presented.

### BACKGROUND OF THE INVENTION

I. Field of the Invention

The present disclosure relates generally to the fields of chemistry and materials science. More particularly, it concerns the synthesis of a graphene films from compounds, such as simple cyclic solvents.

II. Description of Related Art

Graphene is a flat monolayer of carbon atoms tightly packed into a two-dimensional honeycomb lattice, and is a basic building block for graphitic materials of all other dimensionalities.

Known methods for producing graphene films include deposition methods, epitaxial growth on silicon substrate, epitaxial growth on metal substrates, hydrazine reduction, sodium reduction of ethanol, and growth from nanotubes. Brief descriptions of these known methods are as follows. In one method variously known as the “drawing method” or the “deposition method,” graphite is drawn across a silicon substrate, leaving sediments behind that include graphene monolayers. These sediments are located and isolated, producing graphene crystallites up to one millimeter in diameter.

In other methods, silicon carbide is heated to a high temperature, i.e., over 1100° C. The thickness, mobility, and carrier density of the graphene film vary depending on which side of the substrate is used, the silicon-terminated side or the carbon-terminated side.

Similar epitaxial growth methods may use a metal substrate such as ruthenium or iridium instead of silicon carbide. These methods use the atomic structure of a metal substrate to seed the growth of the graphene. Graphene grown on ruthenium typically yields a sample with a non-uniform thickness of graphene layers, and bonding between the bottom graphene layer and the substrate may affect the properties of the carbon layers. Graphene grown on iridium, in contrast, is very weakly bonded, uniform in thickness, and can be made highly ordered. However, as is common with other metal substrates, graphene grown on iridium is slightly rippled. Due to the long-range order of these ripples generation of minigaps in the electronic band-structure becomes visible. High-quality sheets of few layer graphene exceeding 1 cm² in area have been synthesized via chemical vapor deposition on thin nickel films. These sheets have been successfully transferred to various substrates, demonstrating viability for numerous electronic applications. An improvement of this technique has been found in copper foil where the growth automatically stops after a single graphene layer, and arbitrarily large graphene films can be created.

Other known methods for forming a graphene film include hydrazine reduction. In this method, graphene oxide paper is placed in a solution of pure hydrazine, which reduces the graphene oxide paper into single-layer graphene.

Finally, graphene films may be formed by cutting carbon nanotubes. In one such method multi-walled carbon nanotubes are cut open in solution by action of potassium permanganate and sulfuric acid. In another method graphene nanoribbons are produced by plasma etching of nanotubes partly embedded in a polymer film.

Known methods for producing graphene films are expensive, require high-temperature manufacturing processes, or cannot reliably produce graphene having uniform properties on a large scale, or a combination of these drawbacks. For example, known methods of graphene production from SiC are performed at very high temperatures that are not conducive to the use of other semiconductor materials. In addition, producing graphene from nanotubes is not feasible at a large scale because nanotubes do not produce homogenous material required for high volume manufacturing.

### SUMMARY OF THE INVENTION

The present disclosure provides methods of making graphene film by exposure to ultraviolet light.

In one aspect, the disclosure provides a method of making a graphene film comprising:

(a) obtaining a first compound that is a liquid alicyclic- or aromatic-hydrocarbon; and

(b) irradiating the first compound with ultraviolet light under conditions to yield a graphene film.

In certain aspects, the graphene film may be planar, or the graphene film may be non-planar. In other aspects, the disclosure further provides a method comprising:

(c) obtaining a second compound; and

(d) irradiating the second compound.

In another aspect, the disclosure provides a method of coating a material comprising:

(a) obtaining a first compound having a liquid alicyclic or an aromatic hydrocarbon;

(b) applying the first compound to a substrate in an inert atmosphere; and

(c) irradiating the first compound in the inert atmosphere to yield graphene film.

The material may be a semiconductor. The first compound may be selected from the group consisting of benzene, cyclohexane, decalin, or perhydropyrene.

In other aspects, the method further comprises the steps of:

(d) obtaining a second compound; and

(e) irradiating the second compound.

In some embodiments, the first compound may be selected from the group consisting of benzene, cyclohexane, decalin, or perhydropyrene. In certain embodiments, the first compound comprises a 5-, 6-, or 7-membered alicyclic ring. The first compound may be between 99% and 99.999% pure by weight.

In certain embodiments, the ultraviolet light has a wavelength less than 300 nanometers. In other embodiments, the ultraviolet light has a wavelength less than or equal to 193 nanometers.

The disclosed methods may further comprise the step of admixing a polyaromatic hydrocarbon to the first compound to form a solution. In certain embodiments, the polyaromatic hydrocarbon is naphthalene, anthracene or pyrene. The polyaromatic hydrocarbon may be 5-15% of the solution pure by weight.

In addition, the disclosed methods may further comprise the step of coating a substrate with the first compound or the solution. The substrate may comprise Si or Ge. In other aspects, the substrate is a Si-, Ge- or Group III/V-based semi-conductor material. Or the substrate may comprise quartz.

In some aspects, the disclosure provides that the step of irradiating the first compound occurs in an inert atmosphere. The inert atmosphere may be N₂ or Ar. In certain embodiments, the atmosphere may contain O₂ concentrations less than 1 ppm. The irradiating step may be performed using a laser. In certain aspects, the laser is imaged lithographically on a substrate.

In certain aspects, the disclosure further provides the step of admixing the first compound with a dopant to form a mixture. The dopant may comprise K, O, S, N, P, or Al. The disclosed methods may further comprise the additional step of inducing a bandgap between layers of graphene film.

In still other aspects, the disclosure provides a coated wafer comprising a wafer substrate; and a graphene film made according to the disclosed methods.

### BRIEF DESCRIPTION OF THE DRAWINGS

The following drawings form part of the present specification and are included to further demonstrate certain aspects of the present disclosure. The invention may be better understood by reference to one of these drawings in combination with the detailed description of specific embodiments presented herein.

FIG. 1 illustrates schematic diagram of an embodiment of a process for manufacturing a pure graphene film.

FIG. 2 illustrates an embodiment of an apparatus to form a graphene film on a substrate.

FIG. 3 illustrates an embodiment of an apparatus to form a graphene film on a substrate.

FIG. 4 illustrates the chemical reaction from cyclohexane to form hexa-peri-hexabenzocoronene.

FIG. 5 illustrates a schematic diagram of an embodiment of a process for manufacturing a strained graphene film.

FIG. 6 illustrates a table of ring strain values for rings with n members.

FIG. 7 illustrates a portion of a strained graphene molecule.

FIG. 8 illustrates a schematic diagram of an embodiment of a process for manufacturing a doped graphene film.

FIG. 9 illustrates several species for doping nitrogen into a graphene film.

FIG. 10 illustrates several species for doping sulfur into a graphene film.

FIG. 11 illustrates a schematic diagram of a fluid handling system.

FIG. 12 illustrates a schematic diagram of in-situ laser metrology.

### DESCRIPTION OF ILLUSTRATIVE EMBODIMENTS

Disclosed herein are methods of solution-based synthesis of graphene films.

### I. DEFINITIONS

Any undefined valency on an atom of a structure shown in this application implicitly represents a hydrogen atom bonded to the atom.

The term “alicyclic-” refers to an organic compound that is both aliphatic and cyclic that contains one or more all-carbon rings which may be either saturated or unsaturated, but do not have aromatic character. Alicyclic compounds may or may not have aliphatic side chains attached. Examples of alicyclic compounds include cyclopropane, cyclobutane, cyclohexane, decalin, and norbornene and norbornadiene. Spiro compounds have bicyclic connected through one carbon atom.

The term “aromatic-” refers to a hydrocarbon characterized by general alternating double and single bonds between carbons. Aromatic hydrocarbons can be monocyclic or polycyclic. Examples of aromatic hydrocarbons include toulene, ethylbenzene, p-xylene, m-xylene, durene, 2-phenylhexane, biphenyl, phenol, nitrobenzene, benzoic acid, aspirine, and paracetamol.

The term “polyaromatic-” refers to a hydrocarbon characterized by multiple fused aromatic rings, which rings may contain four, five, or six member. Examples of polyaromatic hydrocarbons include but are not limited to anthracene, benzopyrene, chrysene, coronene, corannulene, tetracene, naphthalene, pentacene, phenathrene, pyrene, triphenylene, and ovalene.

The term “dopant” refers to a trace impurity element that inserted into a substance in low concentrations to alter the electrical properties or the optical properties of the substance. For example, a dopant may be inserted into the lattice of a graphene film to alter the electrical properties or optical properties of the film. Examples of dopants include but are not limited to K, O, S, N, P, and Al.

The use of the word “a” or “an,” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the inherent variation of error for the device, the method being employed to determine the value, or the variation that exists among the study subjects.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

An “isomer” of a first compound is a separate compound in which each molecule contains the same constituent atoms as the first compound, but where the configuration of those atoms in three dimensions differs.

The term “saturated” when referring to an atom means that the atom is connected to other atoms only by means of single bonds.

In addition, atoms making up the compounds of the present invention are intended to include all isotopic forms of such atoms. Isotopes, as used herein, include those atoms having the same atomic number but different mass numbers. By way of general example and without limitation, isotopes of hydrogen include tritium and deuterium, and isotopes of carbon include ¹³C and ¹⁴C. Similarly, it is contemplated that one or more carbon atom(s) of a compound of the present invention may be replaced by a silicon atom(s). Furthermore, it is contemplated that one or more oxygen atom(s) of a compound of the resent invention may be replaced by a sulfur or selenium atom(s).

The above definitions supersede any conflicting definition in any of the reference that is incorporated by reference herein. The fact that certain terms are defined, however, should not be considered as indicative that any term that is undefined is indefinite. Rather, all terms used are believed to describe the invention in terms such that one of ordinary skill can appreciate the scope and practice the present invention.

### II. SYNTHETIC METHODS

Graphene films of the present disclosure may be made using the methods outlined below. These methods can be further modified and optimized using the principles and techniques of chemistry and/or materials science as applied by a person skilled in the art.

The following are included to demonstrate preferred embodiments of the invention. It should be appreciated by those of skill in the art that the techniques which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

Various embodiments of methods for production of a uniform graphene film may be useful in the manufacture of, for example, semiconductors and energy-dense batteries. In certain applications, it is desirable to manufacture substantially uniform, homogenous graphene films, referred to here as “pure” graphene films. In other applications, it is desirable to manufacture a graphene film in which 5- and 7-membered rings are introduced into the graphene structure to create a strain within the graphene film. These will be referred to here as “strained” graphene films. In still other applications, it is desired to homogenously dope the graphene film with certain specimens. These will be referred to as “doped” graphene films.

The disclosed methods of manufacturing the various pure, strained, and doped graphene films share certain features and steps in common. Primarily, the disclosed embodiments share the steps of irradiating an organic compound with ultraviolet light. The following discussion will begin with methods for the manufacture of pure graphene films, then proceed to methods for the manufacture of strained graphene films and doped graphene films.

A. Methods of Manufacturing Pure Graphene Films

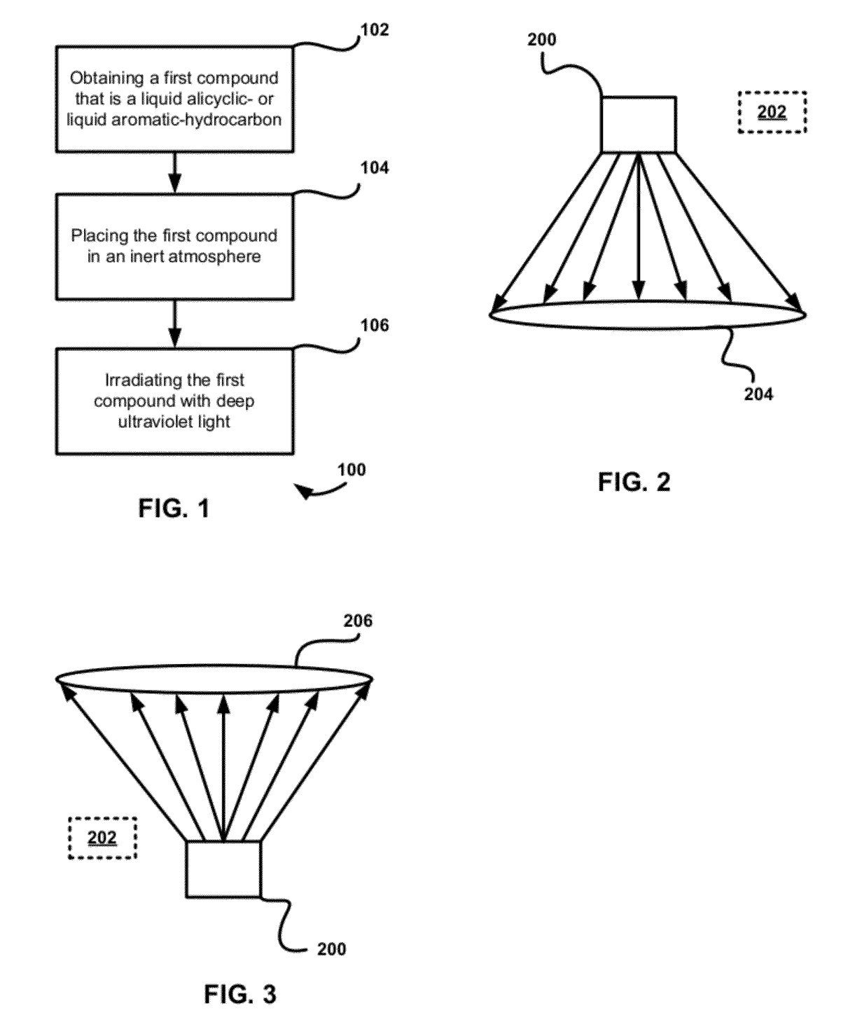

FIG. 1 provides a schematic diagram showing how pure graphene films may be manufactured in certain embodiments of the present disclosure. First, an ultra-pure liquid alicyclic- or liquid aromatic-hydrocarbon compound is obtained. An ultra-pure compound may be at least 99%, 99.9%, 99.99%, or 99.999% pure by weight. Examples of liquid compounds that may be used include cyclohexane, decalin, perhydropyrene, or benzene.

Next, the liquid compound is introduced into an inert atmosphere. The inert atmosphere may be a pure nitrogen atmosphere or noble gas atmosphere. The inert atmosphere preferably contains less than 1 ppm of O₂.

The liquid compound is then irradiated with a deep ultraviolet (DUV) light. DUV light has a wavelength less than or equal to about 300 nanometers. In certain embodiments, the DUV light has a wavelength of around 193 nanometers.

As shown in FIG. 2, in certain embodiments, a graphene film may be generated on a wafer-type substrate. The ultra-pure liquid compound is deposited on a wafer 204 and placed in an inert atmosphere 202. In certain embodiments, wafer 204 is spin coated with the liquid compound to obtain a desired thickness of the compound. In certain embodiments, wafer 204 may comprise Si, Ge, or a Group III/V-based semiconductor material.

A light source 200 emits pulses of DUV light. In certain embodiments, light source 200 is a 4-kHz laser. Wafer 204 is irradiated with the laser at a fluence between 1 and 3 mJ/cm²/pulse. In certain embodiments, the fluence may be attenuated using an ML2100 VARILUX variable electric attenuator from Metrolux Corporation, Metrolux Optische Messtechnik GmbH, Bertha-von-Suttner Strasse 5, D-37085 Göttingen, Germany.

DUV light from light source 200 may be scanned directly onto wafer 204 in some embodiments. In other embodiments, light source 200 may be scanned lithographically onto wafer 204 to form a desired pattern.

FIG. 3 illustrates an embodiment for generating a graphene film on a quartz substrate. In this embodiment, the ultra-pure liquid compound is deposited on a quartz substrate 206. Transmission of DUV light from light source 200 is monitored during graphene formation such that graphene layers may be deposited in a reproducible manner and a desired thickness can be obtained.

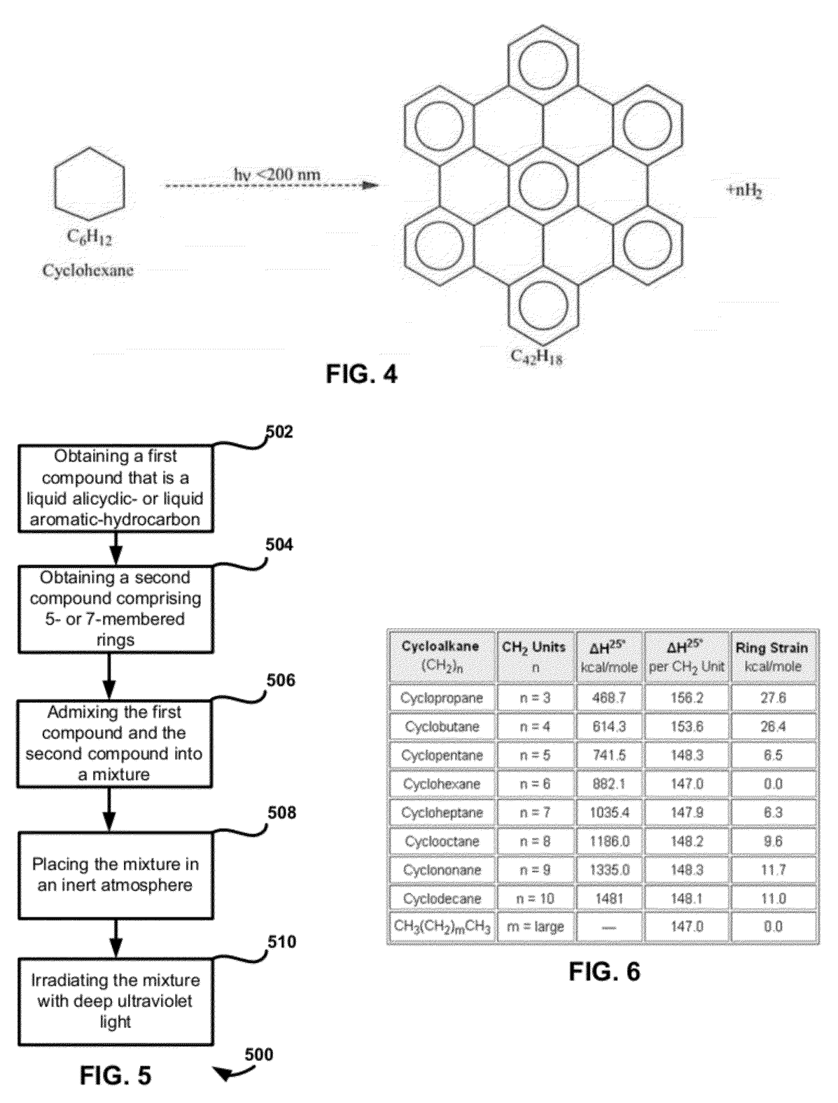

The reaction of cyclohexane to form hexa-peri-hexabenzocoronene is illustrated. in FIG. 4, which shows a portion of a TOF-SIMS mass spectrum from a cyclohexane to form graphene. The structure obtained, C₄₂H₁₈ has been grown according to the methods disclosed in the discussion of FIGS. 1-3 above. FIG. 4 shows the conversion of cyclohexane to hexa-peri-hexabenzocoronene.

B. Methods of Manufacturing Strained Graphene Films

The methods for manufacturing a pure graphene discussed above may be used to create strained graphene films. Strained graphene films may increase hole mobility values and electron mobility values. Additionally, strained graphene films may be produced that cover an entire substrate.

A schematic diagram is shown in FIG. 5 for one embodiment of a method for creating strained graphene films. As in the methods disclosed for generating pure graphene films, an ultra-pure liquid alicyclic- or liquid aromatic-hydrocarbon compound is obtained. Then, 5- or 7-membered ring cycloalkanes are introduced to the first compound. In certain embodiments, the 5- and 7-membered rings are introduced to the first compound stoichiometrically; that is, for substantially each 5-membered ring, a corresponding 7-membered ring is present in the overall structure of the film. An imbalance of 5- and 7-membered rings may create defects in the film.

A table of ring strain values is shown in FIG. 6; ring strain values appear in the last column. The number of members (or CH₂ units), n, is shown in the second column. As shown in the table, the ring strain value of a 6-membered ring is zero. The ring strain value of a 5-membered ring is 6.5 kcal/mole, while the ring strain value of a 7-membered ring is 6.3 kcal/mole. In some embodiments, the presence of these 5- and 7-membered rings in the compound impart to the graphene film a substantial and tunable strain.

In some embodiments, the first compound and a second compound comprising 5-membered rings, 7-membered rings, or both are admixed into a mixture. As in the methods discussed in FIGS. 1-4, the mixture is placed in an inert atmosphere. In preferred embodiments, the inert atmosphere comprises less than 1 ppm of O₂. The inert atmosphere may comprise a noble gas or substantially pure nitrogen gas. Then, the mixture is exposed to DUV light such that a strained graphene film is created. In certain embodiments, the DUV light has a wavelength of less than or equal to about 193 nm.

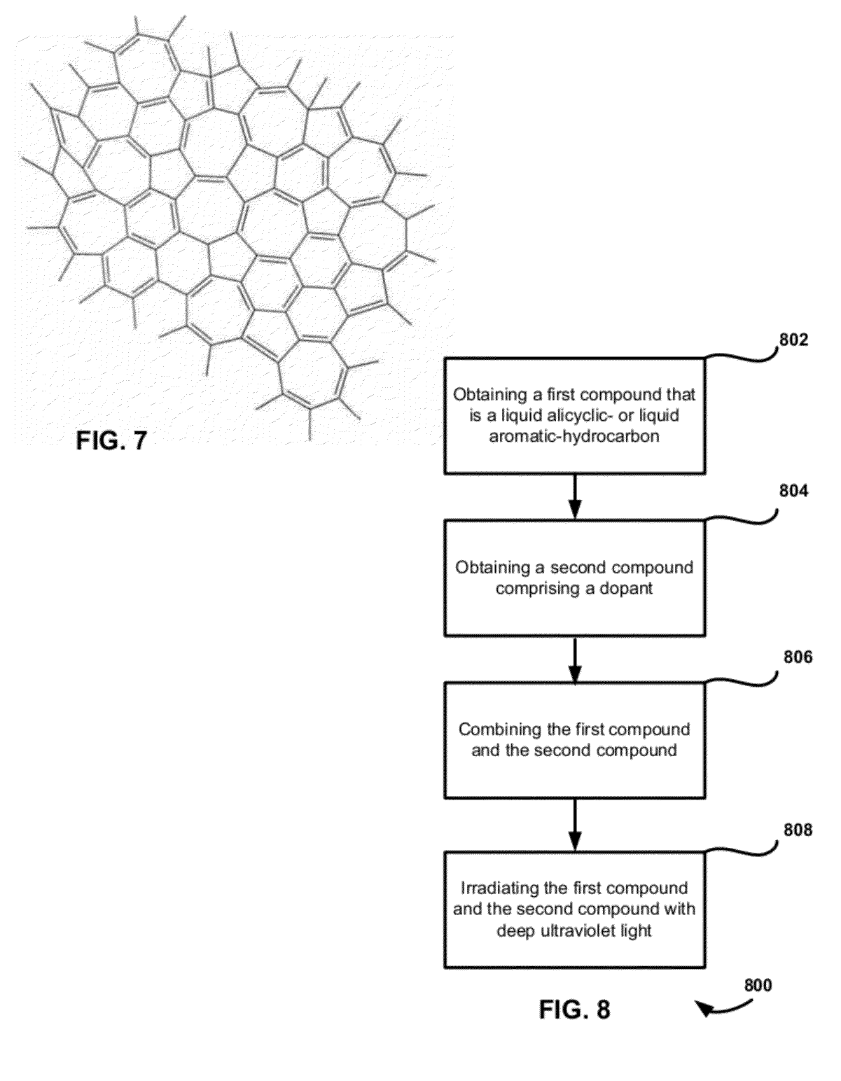

As with the pure graphene film, the substrate may be a semiconducting wafer or quartz. A portion of a strained graphene molecule is shown in FIG. 7.

C. Methods of Manufacturing Doped Graphene Films

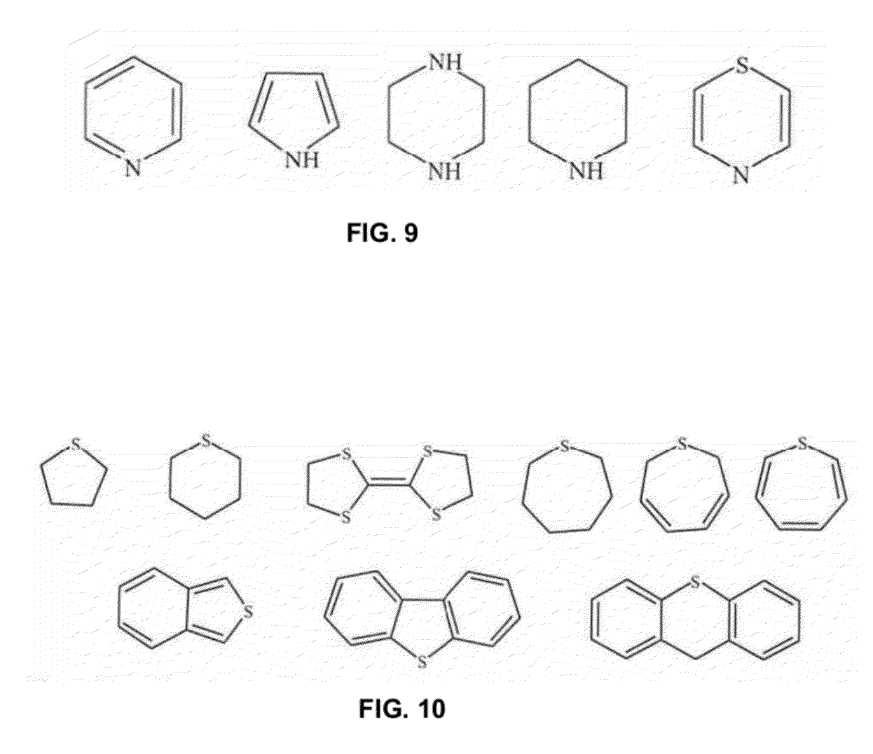

The methods discussed for manufacturing a pure graphene film discussed above may also be used to manufacture doped graphene films, as shown in FIGS. 8-10. In this manner, is possible to introduce a bandgap into a structure comprising multiple layers of graphene film. Using doping, two layers of graphene film may be made nonequivalent such that a bandgap is induced in the structure. For example, one layer may comprise a doped film and the other layer may comprise a pure graphene film. The presence of a bandgap between layers of graphene film may affect the electrical charge transport through the material. In some embodiments, the gap size may be tunable. Structures comprising doped graphene films may be useful in the manufacture of transistors and energy-dense batteries, for example.

Turning now to FIG. 8, a schematic diagram of one embodiment of a method for creating a doped graphene film is shown. As in the previously discussed methods, a first compound comprising an ultra-pure liquid alicyclic- or liquid aromatic-hydrocarbon compound is obtained. A second compound comprising a dopant is then obtained. The first compound and the second compound are combined into a mixture. The compounds may be combined in several ways. In some embodiments, the first compound and the second compound are admixed such that the dopant species may be intercalcated into the graphene film. In other embodiments, the dopant species may be adsorbed into the graphene film.

Examples of dopant species may include K, O, S, N, P, or Al. FIG. 9 shows the chemical structure of possible species for doping nitrogen into graphene layers. FIG. 10 illustrates possible species for doping sulfur into the graphene film.

As in earlier examples, the mixture may then be placed in an inert atmosphere comprising a noble gas or nitrogen. Then, the mixture is exposed to DUV light such that a doped graphene film is created. In certain embodiments, the DUV light has a wavelength of less than or equal to about 193 nm.

In certain embodiments, the methods for manufacturing a pure graphene film and a doped graphene film may be combined to manufacture a multi-layer structure such that a bandgap is induced between the layers.

### III. A WORKING EXAMPLE

The following is a working example of a process for manufacturing a pure graphene film. The inclusion of this working example is not intended to limit the scope of the disclosed invention.

A. Solutions Preparation

1. Purification of Cyclohexane

The following method was adopted to purify cyclohexane. Four liters of Aldrich Spectroscopic grade cyclohexane, (melting point pure 6.55° C.) was recrystallized once to yield two liters of solid. The solid (melting point 4.1° C.) was separated from the bulk, melted and shaken with a 3:1 mixture of concentrated sulfuric and nitric acids at 10° C. to remove aromatic and unsaturated impurities. After separation of the acid layer, the cyclohexane was washed with sodium hydroxide solution and distilled water prior to distillation. This yielded about 500 ml of dry distillate (melting point 5.0° C.) which was stored over sodium wire. Further recrystallizations showed no appreciable improvement in purity (after four recrystallizations the product melted at 5.4° C.). The obtained material was degassed to the point where the O₂ concentration was <1 ppm.

2. Purification of Benzene

The method used to purify benzene is a combination of crystallization and filtration with silica gel. A benzene/ethanol composition is made and then cooled to −10° C., followed by collection of the solid benzene. The benzene is then washed three times with distilled water followed by filtration through silica gel to remove any remaining water or ethanol. The benzene is then dried with phosphorus pentoxide followed by fractional distillation.

Sulfuric acid is used to remove thiophene and various olefins from benzene by a number of different methods. The benzene is shaken with concentrated sulfuric acid followed by washes with water, dilute sodium hydroxide, and water again. At that point the benzene is pre-dried with calcium chloride or another mild drying agent, followed by more rigorous drying with any one of a number of materials such as phosphorus pentoxide, sodium, lithium aluminum hydride, calcium hydride or calcium. The benzene may then be further purified by distillation under an inert atmosphere from a drying agent or by recrystallization methods to achieve >99.99% purity. The obtained material was degassed to the point where the O₂ concentration was <1 ppm.

B. Additives to the Organic Solutions

Compounds such as naphthalene, anthracene, pyrene and other polyaromatic hydrocarbons may be added to a solution in order it enhance the formation of a graphene film. The solution can contain 5% to 15% by weight of any of these materials.

C. Fluid Handling Experimental Details

1. Fluid Sparging and Transmission Qualification Prior to Irradiation

After the organic compounds are purified and their absorbance is qualified for expected purity, they are ready for experimental use. It has been reported that dissolved oxygen can have a significant impact on fluid transmission. Thus, an oxygen sparging procedure is used that insures a oxygen free fluid before irradiation to the levels measured right after fluid purification.

Oxygen sparging of a fluid is performed in a nitrogen-purged glovebox. The glovebox also houses the UV-VUV spectrometer used for transmission qualification. Fluid containers are loaded into the glovebox via a loadlock. Once inside, fluids are transferred into a sparging flask. Sparging is performed by bubbling nitrogen through a metal frit filter (Upchurch Scientific) that is submerged into the fluid. Sparging progress is monitored by collecting the headspace vapor into a gas phase oxygen sensor. After 30 minutes of sparging it is possible to obtain a 193-nm absorbance of cyclohexane of 0.03/cm.

2. Irradiation Chamber

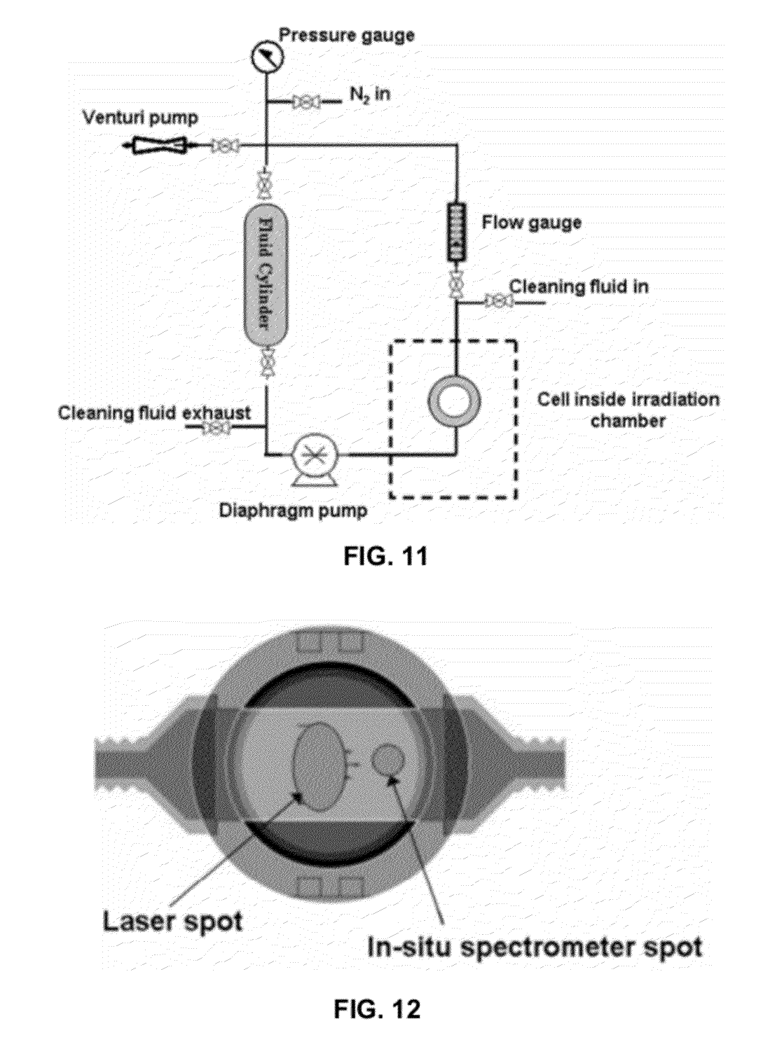

The schematic of the fluid handling system is shown in FIG. 11. The fluid cylinder, isolated by two valves, is attached to the stainless steel plumbing. The plumbing manifold includes a Teflon-diaphragm recirculating pump and the exposure cell, all connected to the cylinder with stainless steel and Teflon lines. During irradiation, the pump delivers the fluid into the exposure cell and then returns it to the top of the fluid cylinder. Typical fluid recirculation rates may be 30 cc/min. For in-situ cleaning with hydrogen peroxide mixture, the fluid cylinder is valved off automatically and a cleaning fluid is pumped through the cell while being irradiated with the laser. A separate valving manifold (not shown) allows for the introduction of different intermediate rinse fluids for compatibility in switching between an organic fluid being exposed and an aqueous-based cleaning solution.

3. Fluid Cell

The fluid cell may be constructed of stainless steel and may use two quartz windows separated by a 2 mm gap, forming a channel for fluid flow. The cell is sealed with Teflon-coated O-rings. The cell is mounted on a translator stage to access different metrology probes of the experiment, as described below. The fluid enters the cell through Teflon tubing, which allows flexibility in cell motion.

4. Laser

The cell is irradiated with a 4-kHz laser at a fluence between 1 and 5 mJ/cm²/pulse. The beam is defined by a 4-mm aperture positioned 2 inches upstream from the sample. At the plane of the cell, the beam is a narrow slit, 5 mm in height and 1.5 mm in width. An ML2100 variable dielectric attenuator from Metrolux Corporation is used to adjust the fluence as necessary, by attenuating it by up to a factor of 50×.

D. In-Situ Metrology

A key finding of in-situ irradiation studies is the existence of two separate mechanisms: bulk fluid degradation and window deposit formation. The latter can result in Graphene layers depositing on the SiO₂ (quartz) surface. In-situ metrology thus is tailored to separate the two phenomena, as shown in FIG. 12. Laser-based transmission measures the combined effect of fluid degradation and window contamination, and only at the irradiating wavelength of 193 nm. Downstream from the laser-irradiated spot, a fiber-based UV-VIS spectrometer measures the transmission of the fluid through the cell without effects of window photocontamination. This measurement can also be made directly at the laser spot to monitor the decrease in absorbance as the carbon layers are deposited. The unique electronic properties of graphene produce an unexpectedly high opacity for an atomic monolayer, with a startlingly simple value: it absorbs πα=2.3% of white light, where α is the fine-structure constant. This has been confirmed experimentally, but the measurement is not precise enough to improve on other techniques for determining the fine-structure constant.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.
Berger et al., Nature 312:1191, 2006
Eberlein et al., Phys. Rev., B78.045403, 2008
Giovannetti et al., Phys. Rev. L., 101:026803, 2008
Lherbier et al., Phys. Rev. L., 101:036808, 2008
Nair et al., Science 10:1126, 2008
Novoselov et al., Science 306:666, 2004
Perrin et al., Perrimrification Laboratory Chemicals, 2nd ed., Pergamon Press, NY 1980
Riddick et al., Organic Solvents, 4th ed., Interscience-Wiley, NY, 1986.
“Graphene Gazing Gives Glimpse Of Foundations Of Universe”, ScienceDaily, 2008
Stankovich et al., J. Matls. Chem., 16:155-158, 2006
Stankovich et al., Nature, 42:282-285
Valenzuela, B., New J. Phys. 10:113009, 2008
Washburn et al., J. Chem: SOC. 41:729, 1919
Zhou, et al. “High refractive index liquid for 193 nm immersion lithography”, RIT Center for Nanolithography Research—Immersion fluids update, 2004
Wehling et al., Nano Letters, 8(1):173-177, 2008.

1. A method of making a graphene film comprising:
(a) obtaining a first compound that is a liquid alicyclic- or liquid aromatic-hydrocarbon; and
(b) irradiating the first compound with ultraviolet light under conditions to yield a graphene film.

2. The method of claim 1, where the graphene film is planar.

3. The method of claim 1, where the graphene film is non-planar.

4. The method of claim 1, where the first compound is selected from the group consisting of benzene, cyclohexane, decalin, or perhydropyrene.

5. The method of claim 4, where the first compound is cyclohexane.

6. The method of claim 1, further comprising
(c) obtaining a second compound; and
(d) irradiating the second compound.

7. The method of claim 6, wherein the first compound comprises 6-membered alicyclic ring.

8. The method of claim 7, where the method further comprises admixing the first compound and the second compound.

9. The method of claim 8, wherein the second compound comprises a 5-membered alicyclic ring.

10. The method of claim 8, wherein the second compound comprises a 7-membered alicyclic ring.

11. The method of claim 1, where the first compound is at least 99%, 99.9%, 99.99%, or 99.99% pure by weight.

12. (canceled)

13. (canceled)

14. (canceled)

15. The method of claim 1, where the ultraviolet light has a wavelength less than 300 nanometers.

16. The method of claim 15, where the ultraviolet light has a wavelength less than or equal to 193 nanometers.

17. The method of claim 1 further comprising placing the first compound in an inert atmosphere having an O₂ concentration of less than 1 ppm.

18. The method of claim 17, where the inert atmosphere comprises a noble gas or nitrogen gas.

19. (canceled)

20. The method of claim 1, further comprising admixing a polyaromatic hydrocarbon to the first compound to form a solution.

21. The method of claim 20, where the polyaromatic hydrocarbon is naphthalene, anthracene or pyrene.

22. The method of claim 20, where the polyaromatic hydrocarbon is 5-15% of the solution pure by weight.

23. The method of claim 1, further comprising sparging the first compound with an inert gas.

24. The method of claim 1 further comprising coating a substrate with the first compound or the solution.

25. (canceled)

26. (canceled)

27. The method of claim 24 where the substrate is a Si-, Ge- or Group III/V-based semi-conductor material.

28. (canceled)

29. The method of claim 1, where irradiating the first compound occurs in an inert atmosphere.

30. The method of claim 29, where the inert atmosphere is predominantly N₂ or Ar.

31. (canceled)

32. The method of claim 29, where the inert atmosphere comprises less than 1 ppm of O₂.

33. The method of claim 1, where irradiating is performed using a laser.

34. The method of claim 33, where irradiating further comprises imaging the laser lithographically on a substrate.

35. The method of claim 1, further comprising admixing the first compound with a dopant to form a mixture.

36. The method of claim 35, where the dopant comprises K, O, S, N, O, or Al.

37.-77. (canceled)
